(19) United States
(12) Patent Application Publication
(10) Pub. No.: US 2015/0081403 A1
(43) Pub. Date: Mar. 19, 2015

(54) Multi-protocol Electronic Tolling System for Nation-wide Use

(71) Applicant: Amtech Systems, LLC, Albuquerque, NM (US)

(72) Inventors: Kelly Gravelle, Poway, CA (US); George McGraw, Corsicana, TX (US); Frank Mestas, Los Ranchos de Albuquerque, NM (US)

(21) Appl. No.: 14/484,980

(22) Filed: Sep. 12, 2014

Related U.S. Application Data
(60) Provisional application No. 61/877,734, filed on Sep. 13, 2013.
(60) Provisional application No. 62/029,851, filed on Jul. 28, 2014.

(51) Int. Cl. G07B 15/06

(52) U.S. Cl. CPC G07B 15/063
USPC 705/13

(57) ABSTRACT

A system is disclosed for assessing roadway toll charges across a plurality of tolling agencies, for example a nation-wide system that allows use of a multi-protocol RFID tag that is recognized in a plurality of states having different tag protocols in their electronic tolling systems. In an embodiment, each tolling agency sets aside numbers associated with the national system. Where a tag is read that is not identified as part of the national system, the local agency processes the tag transaction. There a tag is read that is identified as part of the national system, regardless of which tolling agency reads it, the transaction information is sent to a national customer service center for processing.

### CROSS REFERENCE TO RELATED APPLICATION

This utility application is a non-provisional patent application which claims the benefit under 35 USC 119(e) of provisional application No. 61/877,734 filed on Sep. 13, 2013 and entitled Multi-protocol Electronic Tolling System for Nation-wide Use and of provisional application No. 62/029,851 filed in Jul. 28, 2014 also entitled Multi-protocol Electronic Tolling System for Nation-wide Use. The entire disclosures of these earlier-filed applications are incorporated herein by reference.

### FIELD OF THE INVENTION

The invention relates generally to the field of automated vehicle tolling and particularly to systems and methods for recognizing RFID tags and accurately billing vehicle owners in multiple tolling jurisdictions.

### BACKGROUND

In the United States, there are a variety of electronic tolling systems for roadway use. In some cases each state is responsible for maintaining its tolling system and in others there are multi-state agencies for instances where tolls are collected across state lines. While there are some regional standards wherein the same RFID “tag” is recognized in multiple states, there is no national system. The problem of creating a nationally recognized toll tag is further complicated by the variety of technologies and protocols used by the different tolling authorities. Multiple protocol tags are known that can operate in the various systems used in the United States. For example, TransCore's eZGo Anywhere™ tag is a high speed, high performance radio frequency identification (RFID), interior-mounted transponder suitable for electronic toll collection and traffic management applications. It is a read/write transponder that supports writing data to the transponder at high speeds in real time. This tag is qualified to support SeGo, eGo, IAG, and ATA protocols.

Availability of a multi-protocol tag is solves only part of the problem. In addition, there are many back offices in the United States, 20-30 times as many as there are technology variations in the front end, and except for regional systems there is no mechanism for nationwide account recognition. For example, no mechanism exists today for a toll collected in California to be matched with a customer account in Texas and for the account in Texas to pay the toll from its funds to the road authority in California. It can be a complex problem when considering connecting all back offices throughout the United States.

The existence of a plurality of tolling agencies and of protocols has resulted in often impractical mounting of a plurality of tags on vehicle windshields for vehicles that travel on roadways serviced by these agencies. When a windshield has to be replaced, separate arrangements must be made for replacing each tag as some of these devices are designed to be permanently attached to the windshield to avoid users swapping the devices in unregistered vehicles.

### DESCRIPTION

### FIGURES

FIG. 1 is a flow diagram of an exemplary process for reading and processing electronic toll tags in a nation-wide system.

FIG. 2 is a drawing of an exemplary apparatus for combining two RFID tags into a single unit.

FIG. 3 is a drawing of an exemplary apparatus for combining two RFID tags into a single unit.

FIG. 4 is a drawing of an exemplary apparatus for combining two RFID tags into a single unit.

FIG. 5 is a drawing of an exemplary apparatus for combining two RFID tags into a single unit.

### DETAILED SPECIFICATION

The embodiments described herein are intended to be illustrative only and are not meant to limit the scope of the invention.

In an embodiment of the present invention, a national customer service center (CSC) is responsible for handling tolling transactions for customers using a nationally-recognized multi-protocol tag. Existing tolling systems in the various states and tolling agencies remain unchanged. Participating agencies would agree to give the national CSC a block, or range, of tag IDs, and that will be used to issue multi-protocol tags to customers from the national CSC. Thus, each tag would be identified by a plurality of identification numbers, one for each participating tolling agency. Each agency would continue to process local tags itself. Whenever the agency reads a tag having one of the set-aside numbers designated for national tag use, the transaction data would be sent to the national CSC for processing.

The national CSC would be responsible for establishing and managing relationships with each toll authority within the program. The national CSC would handle all account management responsibilities on behalf of the multi-protocol tag customers, including customer support, inquiries, account/transponder management, and payment processing. The national CSC, which includes an accounting department, will handle all reconciliation and payment of transactions between agencies. No in-lane, back office, or operational changes would be required by toll agencies.

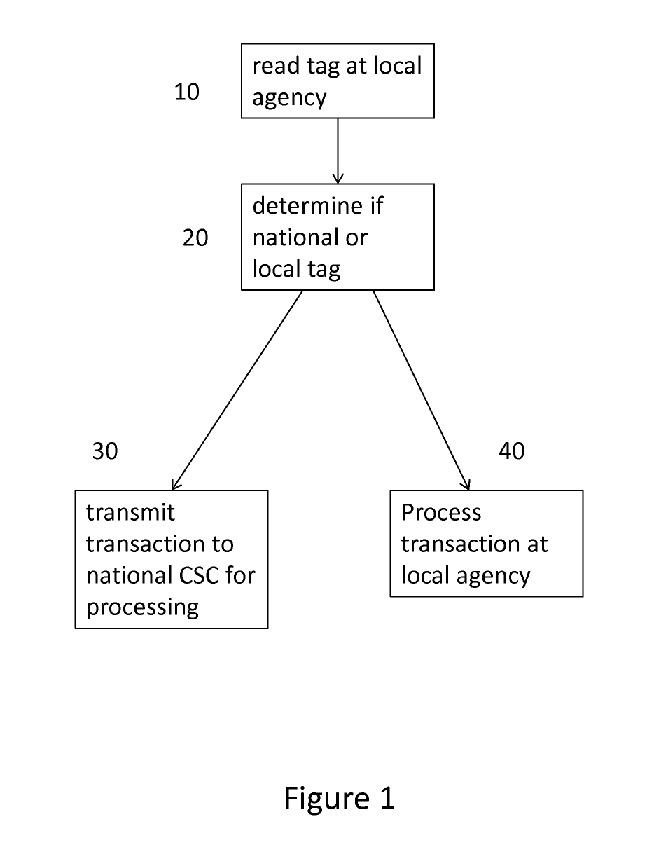

FIG. 1 is an exemplary flow diagram for handling electronic toll tags at the agency level. At step 10, the tag is read at a tolling point. At step 20, the tag number is checked to see if it is a “local” tag or a “national” tag. If the tag is a local tag, the transaction data is sent to the local back office for processing at step 40. If the tag is a national tag, the transaction data is sent to a national CSC for processing at step 30. The same process is implemented across all participating agencies so that every national tag transaction is processed by the national CSC while all local tag transactions are processed at the individual agency's back office.

In a further embodiment of the invention, provisions are made for permanently combining two RFID tags from different systems together to by registered and used as a unit. For example the aforementioned multiprotocol national tag, may still not be accepted by some tolling agencies because, for example, of communication protocol incompatibility or regional desire to maintain a closed system. Regardless of the reason, this situation requires the user to have more than one tag in the vehicle. In this case, the aforementioned national tag can be combined with the outlier system tag into a single unit. Moreover, a single agency may be assigned to register and track usage and payments associated with both of the tags. That agency would simply report any usage and maintain payment to the outlier agency without direct involvement by the user. Thus, the user benefits by only having to purchase and maintain a balance on a single unit, while having the benefit of accessing tolling systems operated under the two tag systems.

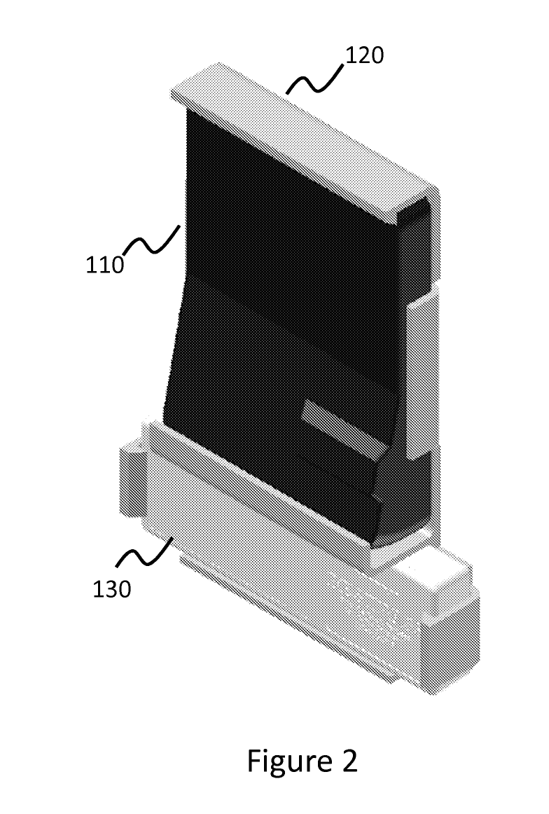

In one embodiment shown in FIG. 2, there is provided a carrier for combining two RFID tags. Various provisions for permanent or semi-permanent attachment of the tags into the carrier are well known in the art. Such attachment is desirable to prevent the user from attempting to separate the tags and use them in different vehicles or transfer one to another user. In a further embodiment, one RFID tag is configured to accept the insertion of or otherwise attach to a second RFID tag.

This holder allows commercial vehicles to have one unit for paying tolls anywhere in the US. The unit is constructed of plastic and can easily be moved from vehicle to vehicle as a unit with the RFID tags inside. In addition, the design allows the use of high strength bonding tape or hook and lock fasteners or other strong means of attachment to make the unit difficult to separate thus making the physical tag linkage permanent or semi-permanent. This makes billing of all toll transactions as a single unit possible.

There are 4 variations to the holder to allow different model tags to be associated into a single unit: PocketPass horizontal, PocketPass vertical, Snap Pass, and Mini PortableSnap.

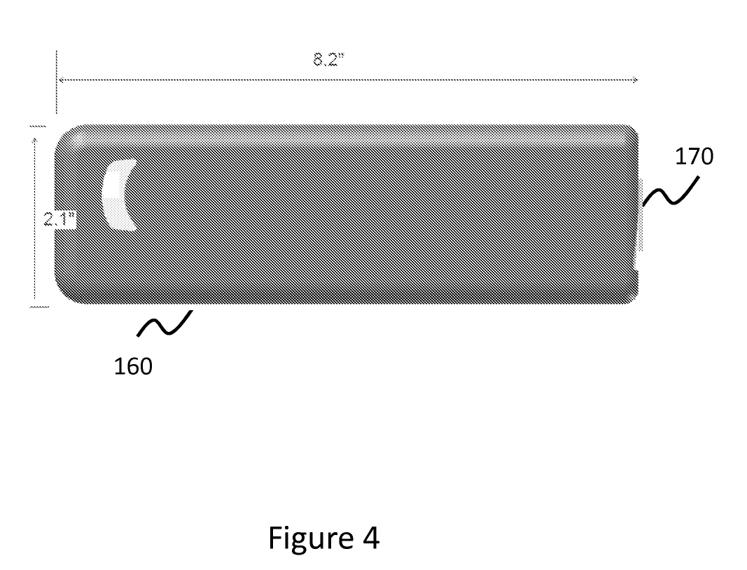

Shown in FIG. 4 is an exemplary PocketPass horizontal comprising a GoAnywherePass plus a G4 mounted side by side. In this model, one tag 170 is inserted into another tag 160 making a unit approximately 8″×2″.

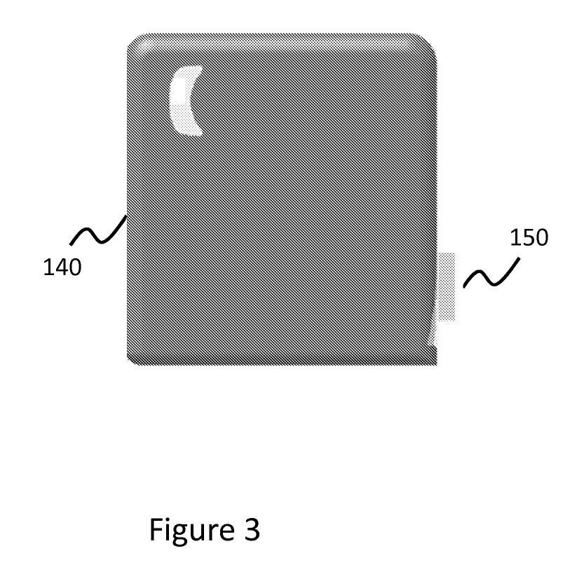

Shown in FIG. 3 is an exemplary PocketPass vertical comprising a GoAnywherePass plus G4 mounted with vertically to each other. In this model, one tag 150 is inserted into another tag 140 making a unit approximately 4.5″×4.5″.

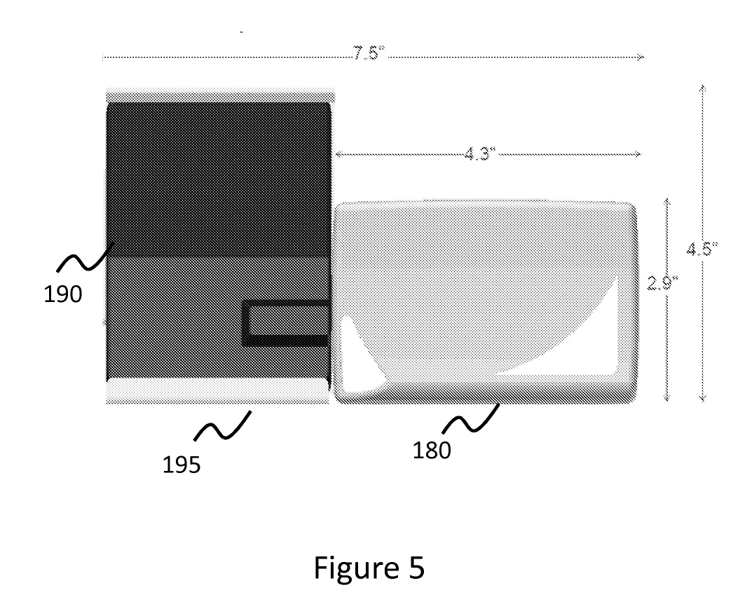

Shown in FIG. 5 is an exemplary Snap Pass comprising a Fusion tag snapped into and open case with a T21/SeGo/ATA tag. In this model, a tag 180 is snapped together with another tag 190 in a carrier 195 to form a single unit approximately 7.5″×4.5″.

Shown in FIG. 1 is a Mini portableSnap comprising a Fusion tag 110 plus a hard case mini tag 130 in a holder 110. In this model, a tag is snapped together with another tag to form a single unit approximately 6″×4.5″.

1. A method for processing electronic vehicle tolling tags comprising:
assigning to a first plurality of tags identification numbers from a first number pool for a first locality,
assigning to a second plurality of tags identification numbers from a second number pool for said first locality,
reading tags from said first and second plurality by a reader located in said first locality,
processing tags having identification numbers from said first number pool at a first processing facility and
processing tags having identification numbers from said second number pool at a second processing facility.

2. The method of claim 1, wherein said first number pool is associated with tags recognized only in said first locality and wherein said second number pool is associated with tags recognized in a plurality of localities including said first locality.

3. The method of claim 2, wherein said tags recognized in a plurality of localities are assigned at least one additional identification number that is recognized in at least one additional locality.

4. The method of claim 3, wherein said tags recognized in a plurality of localities are multi-protocol tags and wherein at least one of said plurality of localities operates a different tag protocol than said first locality.

5. An RFID transponder system for electronic vehicle tolling in a plurality of toll jurisdictions wherein the system is processed by a multi-region processing facility comprising:
a first RFID transponder adapted for recognition in a first toll jurisdiction and having first transponder data and
a second RFID transponder adapted for recognition in a second toll jurisdiction and having second transponder data,
wherein said first and second RFID transponders are configured to be recognized in said toll jurisdictions such that data transmitted by said transponders is processed by the multi-region processing facility.

6. The RFID transponder system of claim 5 further comprising a tag carrier, said tag carrier being configured to secure said first and second transponders together to form a single unit.

7. The RFID transponder system of claim 5, wherein said second RFID transponder is configured to attach to said first RFID transponder to form a single unit.

8. The RFID transponder system of claim 5, wherein said first RFID transponder is a multiprotocol transponder configured to operate in a plurality of toll jurisdictions none of which include said second toll jurisdiction.

9. The RFID transponder of claim 6, wherein said first and second RFID tags are attached to said carrier such that attempting to separate at least one tag from said carrier causes said tag to be inoperable.
